(19) United States
(12) Patent Application Publication
(10) Pub. No.: US 2022/0292479 A1
(43) Pub. Date: Sep. 15, 2022

(54) MERCHANDISE REGISTRATION APPARATUS AND METHOD

(71) Applicant: Toshiba Tec Kabushiki Kaisha, Tokyo (JP)

(72) Inventor: Shigeaki SUZUKI, Gotemba (JP)

(73) Assignee: Toshiba Tec Kabushiki Kaisha, Tokyo (JP)

(21) Appl. No.: 17/541,860

(22) Filed: Dec. 3, 2021

(30) Foreign Application Priority Data
Mar. 12, 2021 (JP) 2021-040212

(51) Int. Cl. G06Q 20/20; G07G 1/00; G06K 7/10; G06F 16/955

(52) U.S. Cl. CPC G06Q 20/208; G07G 1/0045; G06K 7/10297; G06Q 20/203; G06F 16/955

(57) ABSTRACT

A merchandise registration apparatus includes a reader configured to read tag information from a wireless tag attached to merchandise, a memory configured to store the tag information, and a processor. The processor is configured to register the tag information, cause tag information registered in a previous transaction to be stored in the memory, and prevent registration of the tag information in response to the tag information matching the stored tag information.

### CROSS-REFERENCE TO RELATED APPLICATION

This application is based upon and claims the benefit of priority from Japanese Patent Application No. 2021-040212, filed on Mar. 12, 2021, the entire contents of which are incorporated herein by reference.

### FIELD

Embodiments described herein relate generally to a merchandise registration apparatus and a method.

### BACKGROUND

Tag information may be read from a wireless tag such as a radio frequency identification (RFID) tag or the like in which information on merchandise to which the wireless tag is attached. For example, there is a merchandise registration apparatus that reads merchandise information from the wireless tag attached to the merchandise and registers the merchandise information as merchandise related to this transaction.

For example, if merchandise related to a transaction of which payment is already completed remains in the vicinity of an antenna that communicates with a wireless tag, merchandise information may be read from the wireless tag attached to the merchandise of which payment is completed, and the read merchandise information may be registered as merchandise related to this transaction. On the other hand, if the reading of the merchandise information related to this transaction does not start until the merchandise of which payment is completed is removed from the vicinity of the antenna, throughput related to merchandise registration deteriorates.

### DESCRIPTION OF THE DRAWINGS

FIG. 1 is a diagram illustrating an example of a configuration of a point of sales (POS) system according to at least one embodiment;

FIG. 2 is a diagram illustrating an example of a hardware configuration of an RFID scanner;

FIG. 3 is a diagram illustrating an example of a hardware configuration of a POS terminal (e.g., a merchandise registration apparatus);

FIG. 4 is a diagram illustrating an example of a functional configuration of the POS system;

FIG. 5 is a flowchart illustrating an example of a merchandise registration process executed by the POS terminal; and

FIG. 6 is a schematic diagram illustrating an example of a display screen in the merchandise registration process.

### DETAILED DESCRIPTION

Exemplary embodiments of a merchandise registration apparatus and a method capable of improving throughput related to merchandise registration is provided herein.

In general, according to at least one embodiment, a merchandise registration apparatus includes a reading unit (e.g., a reader or reading device), a merchandise registration unit (e.g., a merchandise registration device or register), and a storage unit (e.g., a storage device, a memory). The reading unit reads tag information from a wireless tag attached to merchandise. The merchandise registration unit registers the tag information. The storage unit stores tag information registered in a previous transaction. The merchandise registration unit does not register the tag information read by the reading unit if the tag information read by the reading unit matches the tag information stored in the storage unit.

Hereinafter, a merchandise registration apparatus and a method according to at least one embodiment will be described with reference to the drawings. At least one embodiment describes a merchandise registration apparatus and a method for registering merchandise information read from a wireless tag attached to merchandise, but a technique according to at least one embodiment can also be implemented as an apparatus and a system for registering commodity information read from a wireless tag attached to a commodity, for example, in a distribution system.

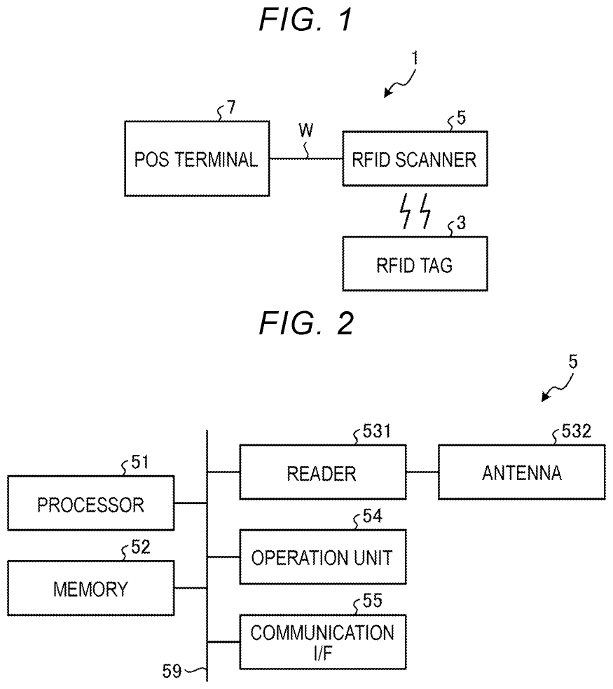

FIG. 1 is a diagram illustrating an example of a configuration of a point of sales (POS) system 1 according to at least one embodiment. As illustrated in FIG. 1, the POS system 1 includes a radio frequency identification (RFID) tag 3, an RFID scanner 5, and a POS terminal 7. The RFID scanner 5 and the POS terminal 7 are communicably connected to each other via a connection line W such as a universal serial bus (USB) cable or the like. The RFID scanner 5 and the POS terminal 7 may be connected to each other by wire or wirelessly. Here, the POS system 1 is an example of a wireless tag reading system.

The RFID tag 3 is also referred to as an IC tag or the like, and has a structure in which an IC chip and an antenna are embedded in a thin film. The RFID tag 3 is a wireless tag that generates electric power if the antenna receives a radio wave and transmits information (e.g., tag information in at least one embodiment) stored in a memory such as a flash memory or the like in the IC chip by the generated electric power. The tag information may be stored in an internal memory according to any format, and various formats such as a serialized global trade item number (SGTIN) format or the like can be appropriately used.

As an example, the tag information is formed of a combination of a plurality of bit strings in a binary format indicating each item of information indicating a size or the like, a header, a company code, a merchandise name, and a serial (e.g., a tag ID). The information indicating the size or the like is a binary value indicating a data size or the like of each information in the tag information. The header is a binary value for identifying a data format of the tag information. The company code is a binary value indicating a code indicating a businessman. The merchandise name is a binary value indicating a code indicating merchandise. Here, a set of the company code and the merchandise name corresponds to a merchandise code of at least one embodiment. The tag ID is a binary value indicating a serial number unique to each of the plurality of RFID tags 3. Here, the merchandise code is an example of a merchandise identifier that identifies merchandise to which the RFID tag 3 is attached. The tag ID is an example of a tag identifier that identifies the RFID tag 3.

The RFID tag 3 has, for example, an adhesive surface, and is attached to a commodity such as merchandise or the like with adhesion. The RFID tag 3 may be attached to the commodity such as the merchandise or the like with a band or the like. The RFID tag 3 may be attached to the commodity by being formed as a part of a package of the commodity such as the merchandise or the like, such as being embedded in the package of the commodity such as the merchandise or the like. Here, the RFID tag 3 is an example of the wireless tag.

The RFID scanner 5 reads the tag information from the RFID tag 3 attached to the merchandise. The RFID scanner 5 outputs the tag information read from the RFID tag 3 to the POS terminal 7 in response to an output request from the POS terminal 7. The RFID scanner 5 is, for example, a stationary type, and may be implemented as a portable handy type scanner. Here, the RFID scanner 5 is an example of a wireless tag reading apparatus.

FIG. 2 is a diagram illustrating an example of a hardware configuration of the RFID scanner 5 according to at least one embodiment. As illustrated in FIG. 2, the RFID scanner 5 includes a processor 51, a memory 52, a reader 531, an antenna 532, an operation unit 54 (e.g., an operation device), and a communication I/F 55. The processor 51, the memory 52, the reader 531, the antenna 532, the operation unit 54, and the communication I/F 55 are connected to each other via a bus 59 or the like.

The processor 51 reads various programs, data files, or the like stored in a read only memory (ROM) and a hard disk drive (HDD) of the memory 52, and loads the various programs, the data files, or the like in a random access memory (RAM) of the memory 52. The processor 51 comprehensively controls an operation of the RFID scanner 5 in cooperation with the various programs, the data files, or the like loaded in the RAM of the memory 52.

The reader 531 uses the antenna 532, thereby transmitting a modulated wave (e.g., a radio wave) for reading the tag information from the RFID tag 3 at predetermined time intervals (for example, at intervals of several tens of milliseconds). The reader 531 reads the tag information stored in the RFID tag 3 via the antenna 532, and outputs the read tag information to the processor 51. The antenna 532 is connected to the reader 531. The antenna 532 is disposed inside, for example, a substantially flat housing. On the housing of the antenna 532, merchandise purchased by a customer, a shopping basket with the merchandise stored, or the like are placed. The antenna 532 outputs a radio wave that can communicate with the RFID tag 3 upward, thereby performing communication with the RFID tag 3 of each merchandise stored in the shopping basket for reading the tag information. The RFID scanner 5 may have a gate-shaped housing. In this case, the antenna 532 is disposed inside the gate-shaped housing, and outputs the radio wave that can communicate with the RFID tag 3 toward the inside of the gate. The operation unit 54 includes various operation keys receiving a user operation. The communication I/F 55 is an interface circuit for being connected to the POS terminal 7. The RFID scanner 5 is connected to the POS terminal 7 via the communication I/F 55.

The POS terminal 7 is a POS register that performs a registration process, a checkout process, or the like of the purchased merchandise, based on the merchandise code read from the RFID tag 3 and a code symbol such as a barcode attached to the merchandise purchased by the customer. Specifically, the POS terminal 7 executes a process related to a transaction (e.g., a commercial transaction) of merchandise corresponding to the merchandise code, based on the merchandise code in the tag information read by the RFID scanner 5. The POS terminal 7 executes a process related to a transaction (e.g., a commercial transaction) of merchandise corresponding to the merchandise code, based on the merchandise code indicated by the code symbol such as the barcode or the like read by a code scanner 76. The transaction indicates a series of procedures related to the purchase of merchandise. More specifically, if the transaction starts, the POS terminal 7 requests the RFID scanner 5 to output the tag information, thereby acquiring the tag information read by the RFID scanner 5. The POS terminal 7 refers to a merchandise master that correlates the merchandise code of each merchandise sold in a store with the merchandise information such as the merchandise name and price of the merchandise, thereby specifying the merchandise corresponding to the merchandise code in the tag information read by the RFID scanner 5 as merchandise to be purchased. Here, the POS terminal 7 is an example of a merchandise registration apparatus.

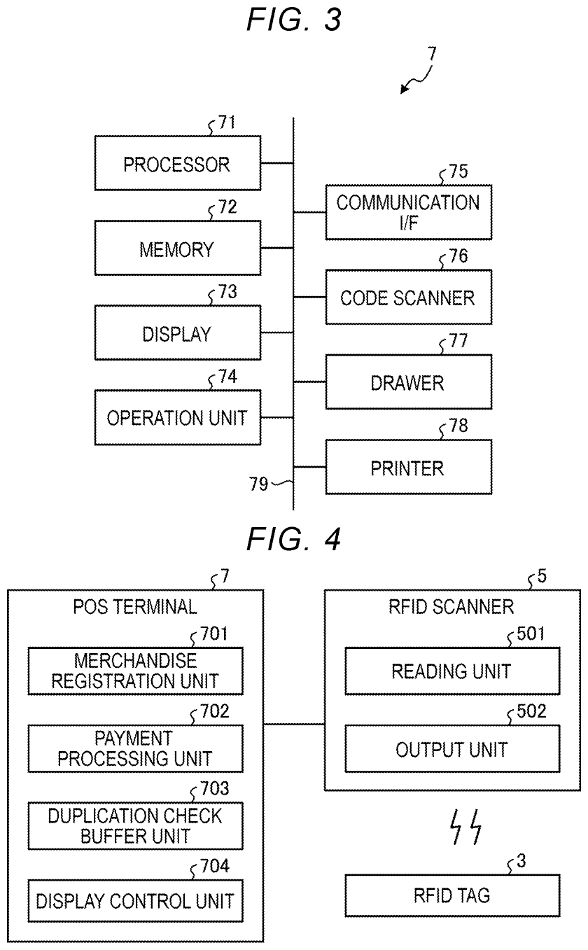

FIG. 3 is a diagram illustrating an example of a hardware configuration of the POS terminal 7 according to at least one embodiment. As illustrated in FIG. 3, the POS terminal 7 includes a processor 71, a memory 72, a display 73, an operation unit 74, a communication I/F 75, the code scanner 76, a drawer 77, and a printer 78. The processor 71, the memory 72, the display 73, the operation unit 74, the communication I/F 75, the code scanner 76, the drawer 77, and the printer 78 are connected to each other via a bus 79 or the like.

The processor 71 reads various programs, data files, or the like stored in a ROM and an HDD of the memory 72, and loads the various programs, the data files, or the like in a RAM of the memory 72. The processor 71 comprehensively controls an operation of the POS terminal 7 in cooperation with the various programs, the data files, or the like loaded in the RAM of the memory 72.

The display 73 is a display such as a liquid crystal display (LCD), and displays various information such as a transaction breakdown or the like. The operation unit 74 includes various operation keys such as a ten key, a transaction start key, and a checkout start key, and receives a user operation. The communication I/F 75 is an interface circuit for being connected to the outside of the RFID scanner 5 and the POS system 1. For example, the code scanner 76 reads the code symbol such as the barcode or the like attached to the merchandise to which the RFID tag 3 is not attached. The code symbol stores the merchandise code or the like for identifying a type of merchandise. For example, the drawer 77 is provided at a lower part of a main body of the POS terminal 7, and stores a coin and a bill. The printer 78 prints a receipt, and discharges the printed receipt from a receipt discharge port provided in the main body of the POS terminal 7. Each of the code scanner 76, the drawer 77, and the printer 78 may not be provided in the POS terminal 7, but may be provided outside the POS terminal 7 and connected via the communication I/F 75. Here, the display 73 is an example of a display unit (e.g., a display device, a display).

As the processors 51 and 71, for example, a central processing unit (CPU) (e.g., a central processor) is used, respectively, and other processors such as a graphics processing unit (GPU) (e.g., a graphics processor), an application specific integrated circuit (ASIC), a field programmable gate array (FPGA), or the like may be used.

The RAM of the memories 52 and 72 is used as a working memory, and is a volatile memory in which data is stored if each of the processors 51 and 71 executes an arithmetic process. The ROM and HDD of the memories 52 and 72 are non-volatile memories that store data such as a program, a parameter, or the like such as a control program or the like executed by the processors 51 and 71, respectively. As each of the memories 52 and 72, for example, the RAM, the ROM, and the HDD are used, and other non-volatile memories such as a solid state drive (SSD), a flash memory, or the like may be used.

The RFID scanner 5 and the POS terminal 7 may be formed to be integrated as one apparatus.

FIG. 4 is a diagram illustrating an example of a functional configuration of the POS system according to at least one embodiment. A part or all of the functions implemented by each apparatus of the POS system 1 may be implemented by cooperation of two or more apparatuses, and may be implemented by a hardware configuration such as a dedicated circuit or the like mounted on each apparatus.

When receiving the radio wave for reading the tag information from the RFID scanner 5, the RFID tag 3 transmits the tag information stored in the internal memory according to the received radio wave.

The processor 51 of the RFID scanner 5 implements functions as a reading unit 501 (e.g., a reading device) and an output unit 502 (e.g., an output device) by executing the control program loaded in the RAM of the memory 52.

The reading unit 501 reads the tag information from the RFID tag 3 attached to the merchandise. Specifically, the reading unit 501 reads the tag information from the RFID tag 3 by the radio wave from the RFID tag 3 in accordance with the radio wave from the antenna 532.

The output unit 502 outputs the tag information read from the RFID tag 3 to the POS terminal 7.

The processor 71 of the POS terminal 7 executes the control program loaded in the RAM of the memory 72, thereby implementing functions as a merchandise registration unit 701 (e.g., a merchandise registration device), a payment processing unit 702 (e.g., a payment processor), a duplication check buffer unit 703 (e.g., a duplication check buffer device), and a display control unit 704 (e.g., a display controller).

The merchandise registration unit 701 reads, by the RFID scanner 5, the tag information from the RFID tag 3 attached to the merchandise, and registers the read tag information. Specifically, the merchandise registration unit 701 performs a merchandise registration process based on the merchandise code in the tag information from the RFID scanner 5. The merchandise registration process is a process of registering the merchandise read by the RFID scanner 5 as merchandise to be purchased. For example, the merchandise registration unit 701 generates a merchandise registration file in which the merchandise information is registered in the merchandise registration process. Here, the merchandise registration unit 701 can also be implemented as an example of a reading unit (e.g., a reading device) that reads, by the RFID scanner 5, the tag information from the RFID tag 3 attached to the merchandise.

On the other hand, the merchandise registration unit 701 does not register the merchandise if it is determined that the same merchandise is registered in this transaction or a previous transaction. Therefore, the merchandise registration unit 701 determines whether or not the same merchandise is already registered in this transaction, based on presence or absence of duplication of the tag ID between the read tag information and the tag information already registered in this transaction. The merchandise registration unit 701 determines whether or not the same merchandise is registered in the previous transaction, based on presence or absence of duplication of the tag ID between the read tag information and the tag information registered in the previous transaction.

After payment related to this transaction is completed, the merchandise registration unit 701 clears a second duplication check buffer of the duplication check buffer unit 703, and deletes the stored tag information of the merchandise registered in the previous transaction. The merchandise registration unit 701 stores the tag information of the merchandise registered in this transaction, which is stored in a first duplication check buffer of the duplication check buffer unit 703, in the second duplication check buffer. After that, the merchandise registration unit 701 clears the first duplication check buffer of the duplication check buffer unit 703, and deletes the tag information of the merchandise registered in this transaction. In other words, after the payment related to this transaction is completed, the merchandise registration unit 701 stores the tag information of the merchandise registered in this transaction, which is stored in the first duplication check buffer of the duplication check buffer unit 703, in the second duplication check buffer as the tag information of the merchandise registered in the previous transaction.

The payment processing unit 702 performs a payment process related to the merchandise registered by the merchandise registration unit 701. The payment process is a process related to payment of one transaction, which is performed based on the merchandise registration file.

The duplication check buffer unit 703 stores the tag information by using the first duplication check buffer and the second duplication check buffer. Here, the duplication check buffer unit 703 is an example of a storage unit (e.g., a storage device, a memory).

The first duplication check buffer is a storage area that stores tag information related to this transaction. That is, the duplication check buffer unit 703 uses the first duplication check buffer to store the tag information registered in this transaction. For example, every time the merchandise is registered, the tag information of the registered merchandise is added to the first duplication check buffer at any time. That is, the payment process executed by the payment processing unit 702 is performed based on the tag information stored in the first duplication check buffer. Here, the tag information stored in the first duplication check buffer is an example of first tag information.

The second duplication check buffer is a storage area that stores tag information related to the previous transaction. That is, the duplication check buffer unit 703 uses the second duplication check buffer to store the tag information registered in the previous transaction. For example, every time the payment of each transaction is completed, the tag information of the merchandise registered in the transaction is added to the second duplication check buffer at any time. Here, the tag information stored in the second duplication check buffer is an example of second tag information.

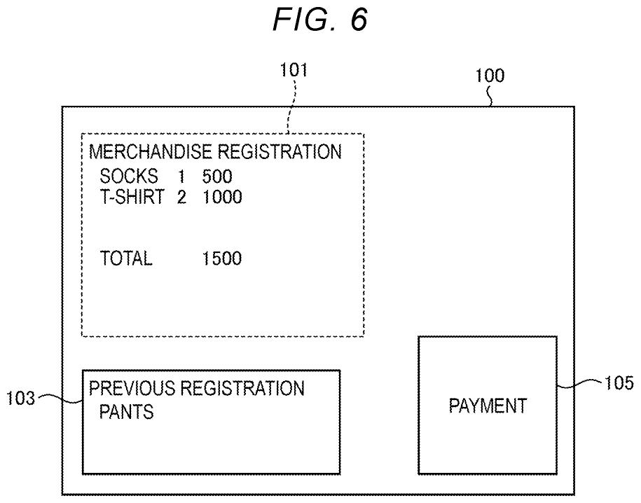

If the payment process starts, the display control unit 704 displays a display screen 100 (e.g., see FIG. 6) including a registered area 101 on the display 73. Here, the registered area 101 is an area provided on the display screen 100 and is an area in which merchandise information of the registered merchandise is displayed. If the merchandise registration unit 701 determines that the same merchandise as the merchandise of which tag information is read is registered in the previous transaction, the display control unit 704 displays the display screen 100 including an unregistered area 103 on the display 73. Here, the unregistered area 103 is an area provided on the display screen 100, and is an area in which merchandise information of merchandise, which is the same as the merchandise registered in the previous transaction, is displayed. The registered area 101 and the unregistered area 103 are, for example, different areas from each other, and are not limited thereto. The registered area 101 and the unregistered area 103 can be visually distinguished from each other on the display screen 100, or may be in an inclusion relationship. The display control unit 704 can also be represented as an example of the display unit.

Here, in the POS system 1 according to at least one embodiment, the previous transaction is, for example, a transaction performed immediately before this transaction (e.g., preceding time). Alternatively, the previous transaction may be a transaction involving a plurality of transactions performed immediately before this transaction, such as the preceding transaction, a transaction performed two times before this transaction, or the like. The previous transaction may be defined by the number of pieces of merchandise registered most recently. The number of pieces of merchandise that defines a scope of the previous transaction can be freely and selectively set. As an example, the previous transaction is a transaction related to the most recently registered 100 pieces of merchandise. Hereinafter, for simplicity of description, the description will be continued with a case, as an example, in which the previous transaction indicates the preceding transaction.

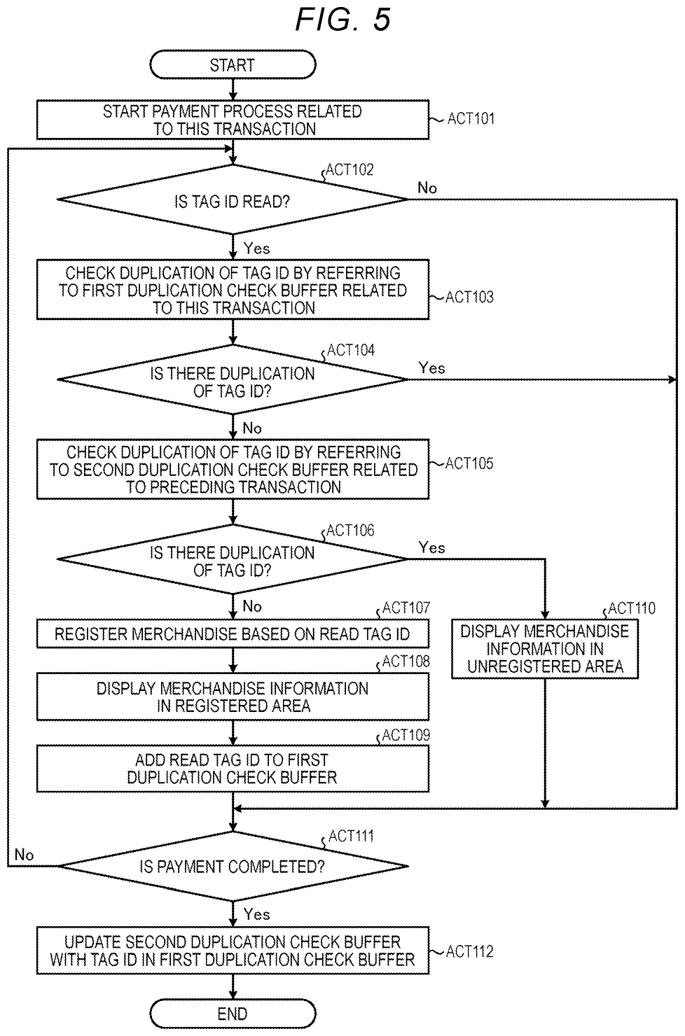

Hereinafter, a flow of a process executed by the POS system 1 according to at least one embodiment will be described with reference to the drawings. FIG. 5 is a flowchart illustrating an example of a merchandise registration process executed by the POS terminal 7 according to at least one embodiment. FIG. 6 is a schematic diagram illustrating an example of the display screen 100 in the merchandise registration process according to at least one embodiment.

The payment processing unit 702 starts a payment process related to this transaction (ACT 101). If the payment process starts, the display control unit 704 displays, on the display 73, the display screen 100 including the registered area 101 in which the merchandise information of the registered merchandise is displayed. At a stage of the process of ACT 101, the registered merchandise is not displayed in the registered area 101.

The merchandise registration unit 701 determines whether or not tag information including a tag ID is read by the RFID scanner 5 (ACT 102).

When determining that the tag ID is read (ACT 102: Yes), the merchandise registration unit 701 checks duplication of the tag ID by referring to the first duplication check buffer related to this transaction (ACT 103). The merchandise registration unit 701 determines whether or not there is the duplication of the tag ID (ACT 104).

In the duplication check that refers to the first duplication check buffer, when determining that there is no duplication of the tag ID (ACT 104: No), the merchandise registration unit 701 checks the duplication of the tag ID by referring to the second duplication check buffer related to the preceding transaction (ACT 105). The merchandise registration unit 701 determines whether or not there is the duplication of the tag ID (ACT 106).

In the duplication check that refers to the second duplication check buffer, when determining that there is no duplication of the tag ID (ACT 106: No), the merchandise registration unit 701 registers the merchandise based on the tag ID of the read tag information (ACT 107).

The display control unit 704 displays the merchandise information of the registered merchandise in the registered area 101 (ACT 108). FIG. 6 illustrates, as the merchandise information of the registered merchandise, a case in which a merchandise name, the number of respective merchandise names, a total amount of respective merchandise names, and a total amount of the entire registered merchandise are displayed.

The merchandise registration unit 701 adds the read tag ID to the first duplication check buffer of the duplication check buffer unit 703 (ACT 109). After that, the flow of FIG. 5 proceeds to a process of ACT 111.

On the other hand, if it is determined that there is the duplication of the tag ID in the duplication check that refers to the second duplication check buffer (ACT 106: Yes), the display control unit 704 displays the merchandise information of the merchandise of which tag information is determined to be read in ACT 102 in the unregistered area 103 of the display screen 100 (ACT 110). FIG. 6 illustrates a case in which the merchandise name is displayed as the merchandise information of the merchandise of which tag ID overlaps with the merchandise registered in the preceding transaction. After that, the flow of FIG. 5 proceeds to the process of ACT 111.

If it is determined that the tag ID is not read (ACT 102: No), and if it is determined that there is the duplication of the tag ID in the duplication check that refers to the first duplication check buffer (ACT 104: Yes), after the process of ACT 109 or after the process of ACT 110, the payment processing unit 702 determines whether or not the payment is completed (ACT 111). The payment is performed, for example, after a customer selects a payment button 105 on the display screen 100. For example, if the payment button 105 is selected, the merchandise registration unit 701 generates a merchandise registration file in which the merchandise information displayed in the registered area 101 is registered. The payment processing unit 702 performs the payment process based on the merchandise registration file.

If it is determined that the payment is not completed (ACT 111: No), the process of FIG. 5 returns to the process of ACT 102.

On the other hand, if it is determined that the payment is completed (ACT 111: Yes), the merchandise registration unit 701 updates the second duplication check buffer with the tag ID in the first duplication check buffer of the duplication check buffer unit 703 (ACT 112). Specifically, the merchandise registration unit 701 deletes the tag ID stored in the second duplication check buffer of the duplication check buffer unit 703. The merchandise registration unit 701 duplicates the tag ID of the registered merchandise, which is stored in the first duplication check buffer of the duplication check buffer unit 703, in the second duplication check buffer. After that, the merchandise registration unit 701 deletes the tag ID stored in the first duplication check buffer of the duplication check buffer unit 703.

In this manner, if it is determined that there is the duplication of the tag ID in the duplication check that refers to the first duplication check buffer and the second duplication check buffer, the flow of FIG. 5 does not execute the process of ACT 107. In other words, the merchandise registration unit 701 does not register the merchandise of which tag information is read if it is determined that there is the duplication of the tag ID.

If reading of the next transaction starts when the merchandise of which payment is completed exists within a reading area of the RFID scanner 5, the merchandise of which payment is completed may be registered as the merchandise related to this transaction. Examples of a case in which the merchandise of which payment is completed exists within the reading area of the RFID scanner 5 includes a case in which a space for bagging merchandise is provided near the RFID scanner 5, a case in which a merchandise registration space and the space for bagging merchandise are common spaces, and a case in which a customer holding bagged merchandise is in the vicinity of the POS terminal 7. On the other hand, if reading related to the next transaction does not start until the merchandise of which payment is completed is away from the reading area of the RFID scanner 5, throughput related to the merchandise registration deteriorates.

In the above-described circumstances, according to the POS terminal 7 of at least one embodiment, it is possible to perform the duplication check at the time of the merchandise registration by using not only the merchandise registered earlier in this transaction, but also the merchandise registered in the previous transaction as a comparison target. That is, according to the POS system 1 of at least one embodiment, if the tag information read by the RFID scanner 5 matches the tag information registered in the previous transaction, which is stored in the memory 72 of the POS terminal 7, the tag information read by the RFID scanner 5 is not registered.

Therefore, according to the technique related to at least one embodiment, the duplication check, in which the merchandise registered in the previous transaction is targeted, can prevent erroneous registration of the merchandise of which payment is completed, while the duplication check, in which the merchandise registered earlier is targeted in this transaction, reduces omission and an error of the reading. If the erroneous registration of the merchandise of which payment is completed can be prevented, since it is not necessary to wait for the start of reading related to the next transaction until the merchandise of which payment is completed is away from the reading area of the RFID scanner 5, thereby making it possible to improve the throughput related to the merchandise registration.

Since the erroneous registration of the merchandise of which payment is completed is prevented, the radio wave for reading may be transmitted for the merchandise registration related to the next transaction at the same time as the payment is completed. Accordingly, since it is possible to omit an operation step, in which a reading start button is operated after a user such as a clerk confirms presence or absence of the merchandise of which payment is completed, the throughput related to the merchandise registration can be improved.

Since the reading can start at the same time as the payment of the transaction performed immediately before this transaction is completed, the merchandise registration can start even before the merchandise is placed in the reading area of the RFID scanner 5. Accordingly, a reading rate can be improved.

According to the POS terminal 7 of at least one embodiment, if there is merchandise registered in the previous transaction among the pieces of merchandise of which tag information is read, the merchandise is displayed separately from the merchandise registered in this transaction. Accordingly, the user can understand the reason why the merchandise registration is not performed if the merchandise is read.

In the POS terminal 7 of at least one embodiment, if it is determined that the same merchandise is registered in the previous transaction, the display control unit 704 may display, on the display 73, an alert indicating that the merchandise is read more than once between a plurality of transactions. The alert may be performed by displaying text information or by displaying an icon. The text information may be a sentence for causing a notification to be generated, for example, “Please note that the merchandise of which payment is completed exists nearby.” The alert may be output to another POS terminal 7 and a management apparatus that manages a plurality of POS terminals 7.

In the POS terminal 7 of at least one embodiment, if it is determined that the same merchandise is registered in the previous transaction, the merchandise registration unit 701 may interrupt registration of another merchandise until the tag information of the merchandise cannot be read. As an example, in the process of ACT 106 of FIG. 5, if it is determined that there is the duplication of the tag ID by the duplication check that refers to the second duplication check buffer, the merchandise registration unit 701 does not execute the processes of ACT 107 to ACT 109 related to another tag ID until the tag ID cannot be read by the process of ACT 102. If it is determined that the same merchandise is registered in the previous transaction, the merchandise registration unit 701 may not execute the payment process until the tag information of the merchandise cannot be read. For example, if it is determined that the same merchandise is registered in the previous transaction, the merchandise registration unit 701 causes the payment button 105 not to work until the tag information of the merchandise cannot be read. At this time, the display control unit 704 may gray out a display of an icon indicating the payment button 105 or interrupt the icon display. In this configuration as well, the same effect as that of the above-described embodiment can be obtained.

As described above, according to at least one embodiment, it is possible to improve the throughput related to the merchandise registration.

Each control program executed by each apparatus (e.g., the RFID scanner 5 and the POS terminal 7) of at least one embodiment is provided by being embedded in the ROM or the like in advance.

Each control program executed by each apparatus (e.g., the RFID scanner 5 and the POS terminal 7) of at least one embodiment may be configured to be provided by being recorded in a computer-readable recording medium such as a CD-ROM, a flexible disk (FD), a CD-R, a digital versatile disk (DVD), or the like in an installable type file or an executable type file.

Each control program executed by each apparatus (e.g., the RFID scanner 5 and the POS terminal 7) of at least one embodiment may be configured to be stored in a computer connected to a network such as the Internet or the like, and to be provided by being downloaded via the network. Each control program executed by each apparatus (e.g., the RFID scanner 5 and the POS terminal 7) of at least one embodiment may be configured to be provided or distributed via the network such as the Internet or the like.

The control program executed by the RFID scanner 5 of at least one embodiment has a modular configuration including the above-described units (e.g., the reading unit 501 and the output unit 502). The CPU (e.g., the processor 51) reads the control program from the storage medium and loads the respective units onto a main storage apparatus. Accordingly, the reading unit 501 and the output unit 502 are generated on the main storage apparatus.

The control program executed by the POS terminal 7 of at least one embodiment has a modular configuration including the above-described units (e.g., the merchandise registration unit 701, the payment processing unit 702, the duplication check buffer unit 703, and the display control unit 704). The CPU (e.g., the processor 71) reads the control program from the storage medium and loads the respective units onto a main storage apparatus. Accordingly, the merchandise registration unit 701, the payment processing unit 702, the duplication check buffer unit 703, and the display control unit 704 are generated on the main storage apparatus.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise registration apparatus, comprising:
a reader configured to read tag information from a wireless tag attached to merchandise;
a memory configured to store the tag information; and
a processor configured to:
register the tag information;
cause tag information registered in a previous transaction to be stored in the memory; and
prevent registration of the tag information in response to the tag information matching the stored tag information.

2. The apparatus of claim 1, wherein the processor is further configured to cause display of, on a display, an alert indicating that the same merchandise is read more than once between a plurality of transactions, in response to the tag information matching the stored tag information.

3. The apparatus of claim 1, wherein the processor is further configured to cause display of, on a display, information indicating merchandise corresponding to the tag information in an area different from information indicating merchandise already registered in a present transaction, in response to the tag information matching the stored tag information.

4. The apparatus of claim 1, wherein the memory is configured to store tag information registered in a present transaction as the tag information registered in the previous transaction after payment related to the present transaction is completed.

5. The apparatus of claim 1, wherein the processor is further configured to interrupt registration of another merchandise until the tag information cannot be read, in response to the tag information matching the stored tag information.

6. A method comprising:
reading tag information from a wireless tag attached to merchandise;
registering the tag information;
storing tag information registered in a previous transaction; and
interrupting registration of the read tag information in response to the read tag information matching the stored tag information.

7. The method of claim 6, further comprising displaying an alert indicating that the same merchandise is read more than once between a plurality of transactions, in response to the tag information matching the stored tag information.

8. The method of claim 6, further comprising displaying information indicating merchandise corresponding to the tag information in an area different from information indicating merchandise already registered in a present transaction, in response to the tag information matching the stored tag information.

9. The method of claim 6, further comprising storing tag information registered in a present transaction as the tag information registered in the previous transaction after payment related to the present transaction is completed.

10. The method of claim 6, further comprising interrupting registration of another merchandise until the tag information cannot be read, in response to the tag information matching the stored tag information.

11. A non-transitory computer readable medium configured to store instructions, which, when executed by a processor, cause operations to be carried out, the operations comprising:
reading tag information from a wireless tag attached to merchandise;
registering the tag information;
storing tag information registered in a previous transaction; and
interrupting registration of the read tag information in response to the read tag information matching the stored tag information.

12. The non-transitory computer readable medium of claim 11, wherein the operations further comprise displaying an alert indicating that the same merchandise is read more than once between a plurality of transactions, in response to the tag information matching the stored tag information.

13. The non-transitory computer readable medium of claim 11, wherein the operations further comprise displaying information indicating merchandise corresponding to the tag information in an area different from information indicating merchandise already registered in a present transaction, in response to the tag information matching the stored tag information.

14. The non-transitory computer readable medium of claim 11, wherein the operations further comprise storing tag information registered in a present transaction as the tag information registered in the previous transaction after payment related to the present transaction is completed.

15. The non-transitory computer readable medium of claim 11, wherein the operations further comprise interrupting registration of another merchandise until the tag information cannot be read, in response to the tag information matching the stored tag information.
